(19) United States
(12) Patent Application Publication
(10) Pub. No.: US 2026/0331671 A1
(43) Pub. Date: Oct. 22, 2026

(54) BATTERY MODULE

(71) Applicant: Prime Planet Energy & Solutions, Inc., Tokyo (JP)

(72) Inventor: Satoshi FUJIMURA, Toki-shi (JP)

(21) Appl. No.: 19/571,488

(22) Filed: Mar. 19, 2026

(30) Foreign Application Priority Data
Apr. 22, 2025 (JP) 2025-070318

(51) Int. Cl. H01M 50/242; H01M 10/613; H01M 10/647; H01M 10/656; H01M 50/103; H01M 50/119; H01M 50/15; H01M 50/209

(52) U.S. Cl. CPC H01M 50/242; H01M 10/613; H01M 10/647; H01M 10/656; H01M 50/103; H01M 50/119; H01M 50/15; H01M 50/209

(57) ABSTRACT

A battery module includes: a plurality of battery cells, each of which includes an electrode body and a battery can consisting of a rectangular case body having long side wall portions, an upper short side wall portion, and a lower short side wall portion, and a pair of lid bodies; and a restraint mechanism for restraining the battery cells, stacked with the long side wall portions adjacently arranged facing each other, from both ends in a stacking direction, and including a cooling part for cooling the battery cells by contact with the lower short side wall portions. The restraint mechanism includes a positionally-fixing part for fixing the battery cells in place in a vertical direction. The positionally-fixing part is engaged with an engagement part provided in the case body with a space between the positionally-fixing part and the engagement part in the stacking direction.

### CROSS-REFERENCE TO RELATED APPLICATIONS

This application is based upon and claims the benefit of priority to Japanese Patent Application No. 2025-070318 filed on Apr. 22, 2025, the entire contents of which are incorporated herein by reference.

### BACKGROUND

### Technical Field

This disclosure relates to a battery module constituting a secondary battery used as a power source for hybrid vehicles, electric vehicles, and the like.

### Related Art

In general, secondary batteries used as power sources for hybrid vehicles, electric vehicles, and the like are required to deliver high currents at high voltages. Accordingly, battery modules each consisting of a plurality of battery cells assembled together are employed. Such a battery module includes, for example, a restraint mechanism for restraining multiple flat battery cells stacked side by side in a parallel arrangement by applying pressure on the outermost battery cells inward in a stacking direction. Further, the restraint mechanism typically includes a cooling plate for cooling the bottom surfaces of the battery cells.

In the above battery module, for example, when the battery cells are restrained by that restraint mechanism, displacement, i.e., misalignment, in the vertical direction perpendicular to the stacking direction may occur between the adjacent battery cells due to manufacturing errors of the battery cells, uneven pressure application, etc. Further, the displacement in the vertical direction between the adjacent battery cells may also be caused by expansion of the battery cells due to charging and discharging. If the battery cells are significantly displaced, the bottom surfaces of the battery cells may separate from the cooling part. This could reduce the cooling performance.

As a means for suppressing the displacement of the battery cells, for example, Japanese unexamined patent application publication No. 2022-000866 (JP 2022-000866A) discloses a battery pack including cell holders with support parts (protrusions) protruding toward the wide side surfaces (i.e., the long side wall portions) of the battery cells. The battery cells are supported and fixed in predetermined positions while being compressed by a predetermined deformation amount between the support parts (the protrusions) of the cell holders.

### SUMMARY

### Technical Problems

However, in the technique of JP 2022-000866A, the battery cells are supported and fixed with the wide side surfaces (the long side wall portion) of the battery cells compressed by a predetermined deformation amount by the support parts (the protrusions) of the cell holders. Therefore, for example, if the volume of electrode bodies expand due to their degradation caused by repeated charging and discharging, the wide side surface (the long side wall portion) of each battery cell is apt to be broken or damaged at some portions deformed by the support parts (the protrusions) of the cell holders.

The present disclosure has been made to address the above problems and has a purpose to provide a battery module in which battery cells are restrained by a restraint mechanism so that the battery cells are suppressed from upward displacement, thereby improving the cooling performance of the battery cells, while avoiding damages and the like to the battery cells due to expansion and the like of the battery cells.

### Means of Solving the Problems

(1) To achieve the above-mentioned purpose, one aspect of the disclosure provides a battery module comprising: a plurality of battery cells, each constituting a secondary battery and including: an electrode body; and a battery can made of metal, including: a case body in which the electrode body is housed, the case body having a rectangular tubular shape with end portions that open at both ends in an axial direction and including a pair of long side wall portions, and an upper short side wall portion and a lower short side wall portion perpendicular to the long side wall portions; and a pair of lid bodies closing the end portions of the case body; and a restraint mechanism restraining the plurality of battery cells, stacked with the long side wall portions of the battery cells adjacently arranged facing each other, from both ends in a stacking direction, the restraint mechanism including a cooling part for cooling the battery cells by contact with the lower short side wall portions, wherein the restraint mechanism includes at least one positionally-fixing part for fixing the battery cells in place in a vertical direction, the at least one positionally-fixing part is engaged with an engagement part provided in the case body, and the at least one positionally-fixing part and the engagement part are engaged with each other with a space therebetween in the stacking direction.

(2) In the battery module described in (1), the engagement part may be provided in a joining portion between each of the long side wall portions and the lower short side wall portion and extends in the axial direction of the case body.

(3) In the battery module described in (1) or (2), the restraint mechanism may include: pressure plates applying pressure onto outermost ones of the battery cells staked in the restraint mechanism; and connecting plates connecting the pressure plates, the at least one positionally-fixing part may be a rod-shaped body supported to be movable in the stacking direction by the connecting plates, and extends in the axial direction of the case body, and the engagement part may be an insertion hole through which the rod-shaped body is inserted to pass through the lid bodies contacting the connecting plates.

(4) In the battery module described in (1) or (2), the at least one positionally-fixing part may be a T-shaped body placed between the battery cells adjacently arranged in the stacking direction, the T-shaped body including a base portion fixed on an upper surface of the cooling part and extending in the axial direction of the case body, and the engagement part may be a recessed groove in which each of protruding end portions of the T-shaped body, protruding from the base portion on both sides in the stacking direction, is engaged to be movable back and forth in the stacking direction within the recessed groove.

(5) In the battery module described in (1) or (2), the at least one positionally-fixing part may be an umbrella-shaped protrusion member placed between the battery cells adjacently arranged in the stacking direction, the umbrella-shaped protrusion member including a base portion fixed on an upper surface of the cooling part and extending in the axial direction of the case body, and the engagement part may be a recessed groove in which a locking claw of each of outer edge portions of the umbrella-shaped protrusion member, protruding from the base portion on both sides in the stacking direction, is engaged to be movable back and forth in the stacking direction within the recessed groove.

### BRIEF DESCRIPTION OF THE DRAWINGS

FIG. 1 is a side view of a battery module according to one aspect of an embodiment;

FIG. 2 is a cross-section view of the battery module, taken along a line A-A in FIG. 1;

FIG. 3 is an enlarged cross-section view of a part B of the battery module shown in FIG. 2;

FIG. 4 is an enlarged cross-section view showing a first modified example of the part B of the battery module shown in FIG. 2; and

FIG. 5 is an enlarged cross-section view showing a second modified example of the part B of the battery module shown in FIG. 2.

### DETAILED DESCRIPTION OF THE EXEMPLARY EMBODIMENTS

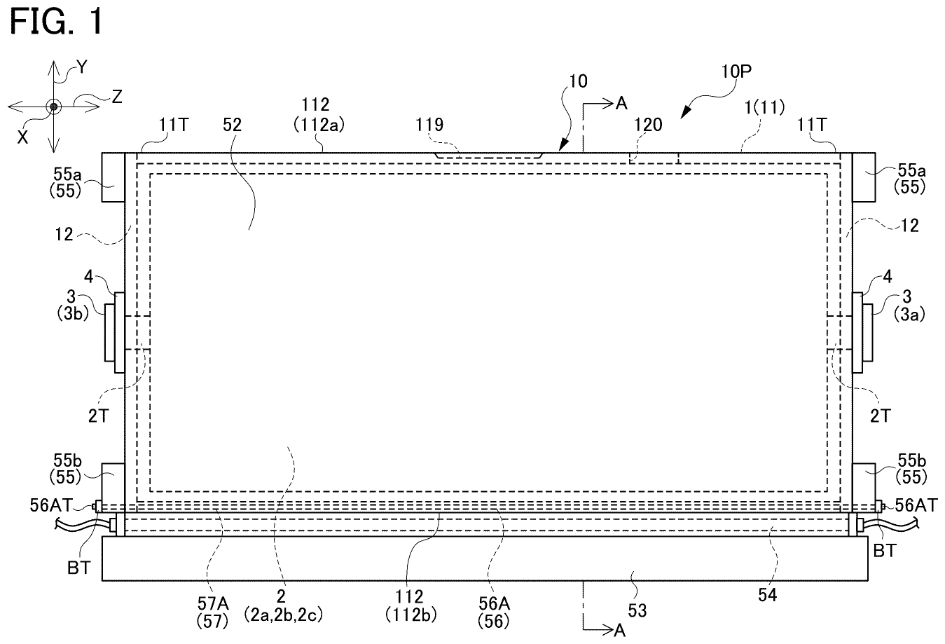

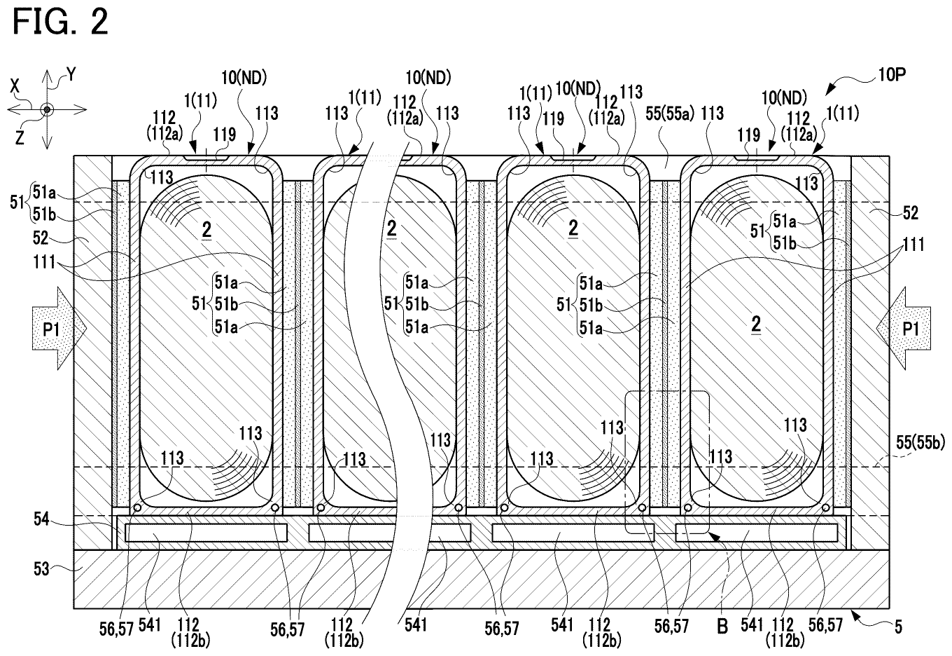

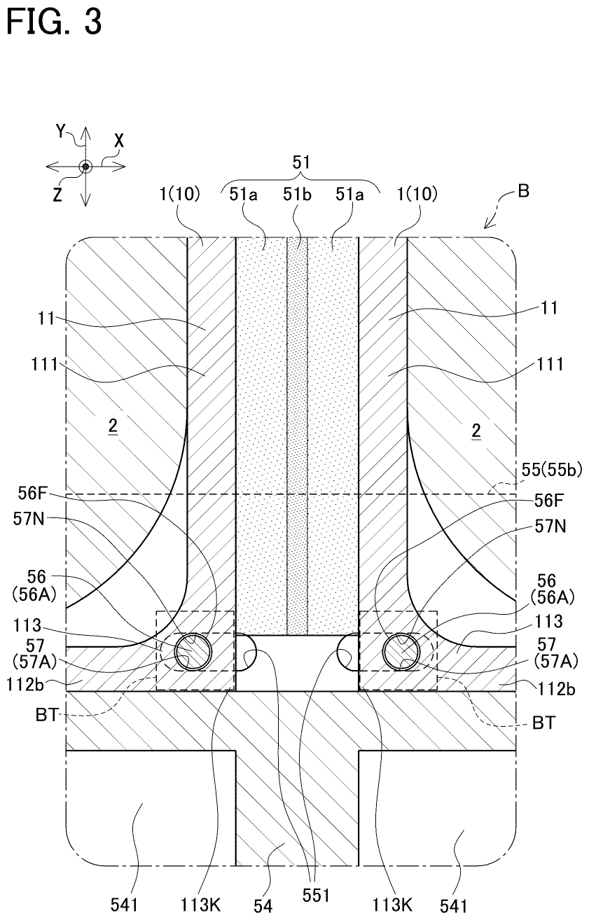

A detailed description of an embodiment of a battery module of the present disclosure will now be given referring to the accompanying drawings. FIG. 1 is a side view of a battery module according to one aspect of the embodiment. FIG. 2 is a cross-section view of the battery module taken along a line A-A in FIG. 1. FIG. 3 is an enlarged cross-section view of a part B of the battery module shown in FIG. 2. In FIG. 1 to FIG. 5, a direction X (“X-direction”) indicates a stacking direction of battery cells of the battery module, a direction Y (“Y-direction”) indicates a width direction of a long side wall portion of a case body, and a direction Z (“Z-direction”) indicates an axial direction of the case body. In addition, the X-direction also corresponds to a width direction of a short side wall portion, the Y-direction also corresponds to a vertical direction of the battery cells, and the Z-direction also corresponds to an axial direction of an electrode body.

A battery module 10P in one aspect of the present embodiment includes, as shown in FIG. 1 to FIG. 3, a plurality of battery cells 10 each constituting a secondary battery ND and including an electrode body 2 and a battery can 1 made of metal. This battery can 1 includes a case body 11, in which the electrode body 2 is housed. The case body 11 has a tubular shape with a rectangular cross-section with end portions 11T that open at both ends in the axial direction. The case body 11 includes a pair of long side wall portions 111, and a pair of short side wall portions 112, i.e., an upper short side wall portion 112a and a lower short side wall portion 112b, perpendicular to the long side wall portions 111. The battery can 1 further includes a pair of lid bodies 12 that sealingly close the end portions 11T of the case body 11. The battery module 10P further includes a restraint mechanism 5 restraining the battery cells 10, stacked with the long side wall portions 111 of the battery cells 10 adjacently arranged facing each other, from both ends, i.e., both outer sides, in the stacking direction (X-direction). The restraint mechanism 5 further includes a cooling part 54 for cooling the battery cells 10 by contacting the lower short side wall portions 112b. In the present embodiment, for example, the restraint mechanism 5 is configured to restrain the battery cells 10 by applying pressure inward in the stacking direction (X-direction), from both ends in the stacking direction (X-direction), while the battery cells 10 are stacked with intervening members 51 interposed between the long side wall portions 111 of the adjacent battery cells 10. Note that the restraint mechanism 5 is not necessarily limited to the above configuration. For instance, the restraint mechanism may be configured to restrain the battery cells 10 from both ends in the stacking direction (X-direction), while the battery cells 10 are stacked without interposing any intervening members between the adjacent battery cells 10. Alternatively, for example, the restraint mechanism may be configured to simply restrain the battery cells 10 from both ends in the stacking direction (X-direction), without applying pressure inward to them in the stacking direction (X-direction).

Here, the electrode body 2 includes a strip-shaped positive electrode foil 2a, a strip-shaped negative electrode foil 2b, and strip-shaped separators 2c sandwiched between those electrode foils 2a and 2b, which are laminated and wound together into a flat shape. However, the electrode body 2 is not necessarily limited to this configuration. For example, the electrode body may be configured such that a plurality of sheet-shaped positive electrode foils and a plurality of sheet-shaped negative electrode foils are alternately laminated with a plurality of sheet-shaped separators each interposed between the opposite electrode foils.

The battery cells 10 each constituting a secondary battery ND may be a lithium-ion secondary battery, for example. In this case, the positive electrode foil 2a may be, for example, an aluminum foil, and the active material bonded thereto may be, for example, lithium transition metal oxides (LiNi_{1/3}Co_{1/3}Mn_{1/3}O₂, LiNiO₂, etc.). The negative electrode foil 2b may be, for example, a copper foil, and the active material bonded thereto may be, for example, graphite, hard carbon, soft carbon, etc. Furthermore, the separators 2c may also be porous sheets made of, for example, polypropylene, polyethylene, etc.

The metal battery can 1 is a metal casing made of, for example, aluminum or aluminum alloy, but is not necessarily limited to these materials. The case body 11 of the battery can 1 is a rectangular tubular body produced by extrusion molding in the axial direction (Z-direction) of the case body 11, with the end portions 11T opening at both ends in the axial direction (Z-direction). The case body 11 is not necessarily limited to this configuration. For example, the case body may also be a rectangular tubular case body produced by any methods other than extrusion molding. The upper short side wall portion 112a is formed with a safety valve 119 that will rupture when the internal pressure of the battery can 1 rises to a predetermined value or more, and a liquid inlet 120 through which electrolyte is injected into the battery can 1. The lid bodies 12 are each formed in a flat plate shape and connected to one of the end portions 11T of the case body 11 by welding or other methods. To each lid body 12, a current collector terminal 3 connected to a tab part 2T formed at each end of the electrode body 2 in the axial direction (Z-direction) is fixed via an insulation member 4 (see FIG. 1). Specifically, a positive current collector terminal 3a is fixed to one of the paired lid bodies 12 for each battery can 1, and a negative current collector terminal 3b is fixed to the other lid body 12.

The intervening members 51 are each interposed between the adjacent battery cells 10 in the battery module 10P and between the battery cell 10 located on each outermost end in the stacking direction and the corresponding pressure plate 52 to suppress excessive increase in pressing force P1 applied by the restraint mechanism 5 when the internal pressure of the battery can 1 rises. Each of the intervening members 51 interposed between the battery cells 10 includes, for example, a sheet-shaped insulation member 51b perpendicular to the stacking direction (X-direction) and plate-shaped elastic members 51a, which are elastically deformable, bonded to both sides of the insulation member 51b. In contrast, each of the intervening member 51 interposed between each of the outermost battery cell 10 and the corresponding pressure plate 52 is configured such that an elastic member 51a is bonded to only the side of the insulation member 51b facing the outermost battery cell 10. Here, the intervening members 51 are each constituted of two parts: the elastic member 51a and the insulation member(s) 51b. However, the intervening members 51 are not limited to this configuration, and may be constituted of a single part that has insulation properties and is elastically deformable.

The restraint mechanism 5 includes a base plate 53, a cooling part 54 placed on the base plate 53, two pressure plates 52 fixed to the base plate 53 and used to apply pressure to outermost ones of the outermost battery cells 10 stacked in the stacking direction, and connecting plates 55 each connecting those two pressure plates 52, and at least one positionally-fixing part 56 (in the present embodiment, a plurality of positionally-fixing parts 56) extending in the axial direction (Z-direction) and fixing the battery cells 10 in place in the vertical direction (Y-direction). The positionally-fixing parts 56 are each engaged with one of engagement parts 57 provided in each case body 11. As shown in FIG. 3, furthermore, the positionally-fixing part 56 and a guide long holes 551 are engaged with each other with a space, or a gap, therebetween in the stacking direction (X-direction). In other words, each battery cell 10 is formed so as to be movable in the stacking direction (X-direction) while the positionally-fixing part 56 and the engagement part 57 are engaged with each other. The cooling part 54 includes refrigerant passages 541 at positions facing the battery cells 10. Each refrigerant passage 541 has approximately the same width as the width of the lower short side wall portion 112b of the battery cell 10 (X-direction), and extends in the axial direction (Z-direction).

As described above, the restraint mechanism 5 includes the positionally-fixing parts 56 for fixing the battery cells 10 in place in the vertical direction (Y-direction). The positionally-fixing parts 56 are each engaged with one of the engagement parts 57 of the case bodies 11. Therefore, when the battery cells 10 are restrained by the restraint mechanism 5, the battery cells 10 are allowed to move back and forth in the stacking direction (X-direction). However, if the battery cells 10 attempt to move upward, the battery cells 10 are suppressed from upward movement by the positionally-fixing parts 56 of the restraint mechanism 5. This configuration ensures that the entire lower surface of each lower short side wall portion 112b of the battery cells 10 is maintained in contact with the cooling part 54. Furthermore, since the positionally-fixing part 56 and the engagement part 57 are engaged with each other with a space, or a gap, between them in the stacking direction (X-direction), even if the battery cell 10 is moved in the stacking direction (X-direction) due to expansion or other reasons, causing the load restraining the battery cells 10 in the stacking direction (X-direction) to act from the positionally-fixing part 56 to the engagement part 57, the battery cell 10 is less likely to be deformed or damaged. Consequently, the present embodiment can achieve the battery module 10P capable of suppressing upward positional displacement of the battery cells 10 restrained by the restraint mechanism 5, improving the cooling performance of the battery cells 10, while avoiding damages to the battery cells 10 even if the battery cell 10 expands.

Moreover, in each battery cell 10, the engagement part 57 engaged with the positionally-fixing part 56 may be provided at the joining portion 113 between one of the long side wall portions 111 and the lower short side wall portion 112b and extended in the axial direction (Z-direction). In this case, since the engagement part 57 extends in the axial direction (ZS direction) of the case body 11 throughout the joining portion 113 having relatively high rigidity, the battery module 10P can be provided, in which each battery cell 10 is even less likely to be deformed or damaged even if the load causing movement of each battery cell 10 acts from the positionally-fixing part 56 to the engagement part 57.

The connecting plates 55 each have a strip plate shape and fasten the two pressure plates 52, between which two or more battery cells 10 are sandwiched in the stacking direction (X-direction), so that the distance between the pressure plates 52 is maintained at a predetermined distance. The connecting plates 55 are placed outside the battery cells 10 in the axial direction (Z-direction) and in contact with the lid bodies 12 of the outermost battery cells 10, as shown in FIG. 1. Specifically, the connecting plates 55 are arranged individually on the upper end side and the lower end side of each lid body 12 of the battery cells 10 having the current collector terminals 3 (the positive current collector terminal 3a and the negative current collector terminal 3b), not on the center of each lid body 12, in the vertical direction (Y-direction). Here, the connecting plate 55 in contact with the lid bodies 12 of the battery cells 10 on the upper end side in the vertical direction (Y-direction) is referred to as an upper connecting plate 55a, and the connecting plate 55 in contact with the lid bodies 12 of the battery cells 10 on the lower end side in the vertical direction (Y-direction) is referred to as a lower connecting plate 55b.

In the battery module 10P in the present embodiment, each of the positionally-fixing parts 56 is a rod-shaped body 56A extending in the axial direction (Z-direction) and supported to be movable in the stacking direction (X-direction) by the connecting plates 55 connecting the pressure plates 52 that apply pressure to the outermost battery cells 10 stacked by the restraint mechanism 5. Each rod-shaped body 56A has a circular cylindrical rod shape and is supported by the lower connecting plates 55b so as to be movable in the stacking direction (X-direction). Specifically, both ends 56AT of each rod-shaped body 56A extending in the axial direction (Z-direction) protrude outward in the axial direction (Z-direction) from guide long holes 551, which are provided in the lower connecting plates 55b and extend in the stacking direction (X-direction). Each end 56AT is connected to a bracket BT for preventing the rod-shaped body 56A from coming off. Each bracket BT has a rectangular shape and is formed to be slidable in contact with the lower connecting plate 55b.

Each of the engagement parts 57 is an insertion hole 57A through which the rod-shaped body 56A is inserted to pass through the lid body 12 that contacts with the connecting plate 55 (the lower connecting plate 55b). The insertion holes 57A are formed in pairs in each battery can 1. Specifically, two insertion holes 57A are formed in each battery can 1; concretely, one in the joining portion 113 between one of the long side wall portions 111 and the lower short side wall portion 112b and the other in the joining portion 113 between the other long side wall portion 111 and the lower short side wall portion 112b, and also two in each lid body 12, i.e., at positions corresponding to the joining portions 113, as shown in FIG. 2 and FIG. 3. In other words, the insertion holes 57A (the engagement parts 57) are formed at the lower portions of each case body 11 on both ends in the stacking direction (X-direction) and the lower portions of each lid body 12. In the battery module 10P in the present embodiment, for example, when the case body 11 has a rectangular tubular shape formed by extrusion molding in the axial direction (Z-direction) of the case body 11 and further the insertion holes 57A are also formed in the case body 11 simultaneously during extrusion molding of the case body 11 in the axial direction (Z-direction), the battery cell 10 can be achieved including the case body 11 efficiently provided with high-precision insertion holes 57A in the axial direction (Z-direction). However, the method for forming the insertion holes 57A is not limited to the above; for example, the insertion holes 57A may be provided after forming or even before forming the rectangular tubular case body 11.

Further, the rod-shaped bodies 56A (the positionally-fixing parts 56) engage with the corresponding the insertion holes 57A (the engagement parts 57) mentioned above. In the battery module 10P in the present embodiment, an inner surface 57N of each insertion hole 57A (each engagement part 57) of the battery cells 10 and an outer surface 56F of each rod-shaped body 56A (each positionally-fixing part 56) of the restraint mechanism 5 are in contact with each other, so that the rod-shaped bodies 56A (the positionally-fixing parts 56) are less likely to be deformed, e.g., bent. Thus, the rod-shaped bodies 56A are resistant to deformation even with a small cross-sectional area. In the present embodiment, consequently, each rod-shaped body 56A can be formed with a relatively small cross-sectional area, and thus the joining portions 113 formed with the insertion holes 57A do not protrude outward in the stacking direction (X-direction) beyond the long side wall portions 111, resulting in a compact battery can 1.

For the battery module 10P in the present embodiment, as described above, each of the positionally-fixing parts 56 is the rod-shaped body 56A supported by the connecting plates 55 in a movable manner in the stacking direction (X-direction), and each of the engagement parts 57 is the insertion hole 57A through which the rod-shaped body 56A is inserted to pass through the lid bodies 12 located in contact with the connecting plates 55. Thus, even when each rod-shaped body 56A has a small cross-sectional area and is thin, each rod-shaped body 56A is resistant to deformation relative to the corresponding insertion hole 57A and can hold the battery cell 10 against upward movement. Further, each insertion hole 57A is formed in the corresponding joining portion 113, which is the corner portion of the rectangular tubular case body 11. This configuration is less likely to interfere with the housing space of the case body 11 in which the electrode body 2 is accommodated, compared to when the insertion holes 57A are formed in, for example, the long side wall portion 111, upper short side wall portion 112a, and lower short side wall portion 112b. Consequently, the battery module 10P can be provided, capable of avoiding a reduction in the housing space of each case body 11 for each electrode body 2 and reliably suppressing upward displacement of the battery cells 10, thereby reliably improving the cooling performance of the battery cells 10.

In each of the battery cells 10 of the battery module 10P in the present embodiment, as shown in FIG. 2, each joining portion 113 between the long side wall portion 111 and the upper short side wall portion 112a is curved with a constant wall thickness throughout the axial direction (Z-direction). In contrast, as shown in FIG. 3, each joining portion 113 between the long side wall portion 111 and the lower short side wall portion 112b, where the insertion hole 57A (the engagement part 57) is formed, has a thick wall thickness including a corner portion 113K formed at a right angle, throughout the axial direction (Z-direction). This configuration enables the joining portion 113 to be thick enough around the insertion hole 57A (the engagement part 57), ensuring adequate strength for the insertion hole 57A (the engagement part 57), while achieving a larger cross-sectional area of the insertion hole 57A (the engagement part 57).

### Modified Examples

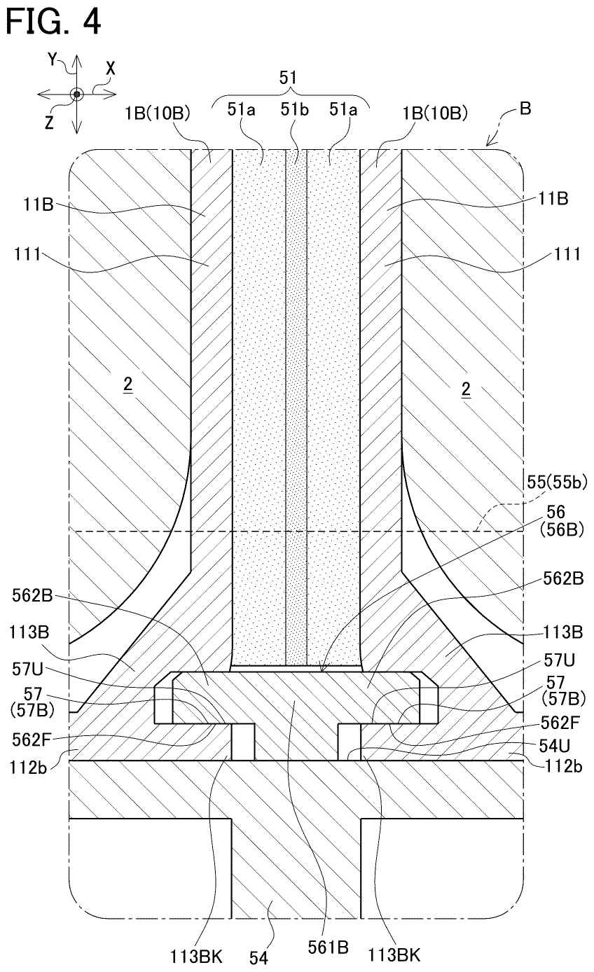

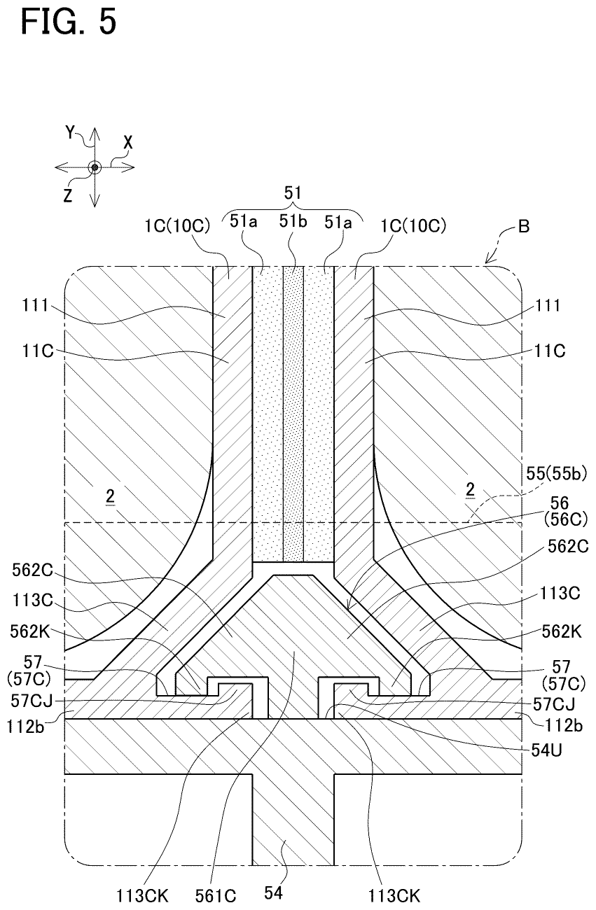

The foregoing embodiment isa mere example and give no limitation to the present disclosure. The present disclosure may be embodied in other specific forms without departing from the essential characteristics thereof. FIG. 4 is an enlarged cross-sectional view showing a first modified example of the part B of the battery module shown in FIG. 2. FIG. 5 is an enlarged cross-sectional view showing the part B of the battery module shown in FIG. 2.

### First Modified Example

A battery module 10P in the first modified example differs from the battery module 10P in the foregoing embodiment in that each of the positionally-fixing parts 56 of the restraint mechanism 5 is a T-shaped body 56B including a base portion 561B fixed on an upper surface 54U of the cooling part 54, between adjacent battery cells 10B, and extending in the extrusion direction (Z-direction) and that the engagement part 57 of each battery cell 10B is a recessed groove 57B in which one of protruding end portions 562B, protruding from the base portion 561B of the T-shaped body 56B on both sides in the stacking direction (X-direction), is engaged so as to be movable back and forth within the groove in the stacking direction (X-direction).

Specifically, as shown in FIG. 4, a battery can 1B of each battery cell 10B includes the recessed groove 57B provided in a joining portion 113B between the side wall portion 111 and the lower short side wall portion 112b and extending in the axial direction (Z-direction) with a rectangular groove cross-section, which is recessed in the width direction (X-direction) of the lower short side wall portion 112b. The recessed grooves 57B are formed on both ends of each battery cell 10B in the stacking direction (X-direction). In the battery module 10P in the first modified example, when the case body 11B has a rectangular tubular shape formed by extrusion molding in the axial direction (Z-direction) of the case body 11B and the recessed grooves 57B of the case body 11B are formed simultaneously during extrusion molding of the case body 11B in the axial direction (Z-direction), the battery cell 10B can be achieved including the case body 11B efficiently provided with the high-precision recessed grooves 57B in the axial direction (Z-direction). However, the method for forming the recessed grooves 57B is not limited to the above; for example, the recessed grooves 57B may be provided after forming or even before forming the rectangular tubular case body 11B.

The restraint mechanism 5 is further formed, on the upper surface 54U of the cooling part 54, with the T-shaped bodies 56B each having a T-shaped cross-section and extending in the axial direction (Z-direction) under the intervening member 51 interposed between adjacent battery cells 10B. Each T-shaped body 56B includes the base portion 561B and the protruding end portions 562B protruding outward from both sides of the base portion 561B in the stacking direction (X-direction). The protruding end portion 562B of the T-shaped body 56B enters in the recessed groove 57B in a movable manner in the stacking direction (X-direction), and the protruding end portion 562B of the T-shaped body 56B is engaged with the recessed groove 57B so that at least and a lower surface 562F of the protruding end portion 562B and an upper surface 57U of the recessed groove 57B are in contact with each other.

In the battery module 10P in the first modified example described above, since the protruding end portions 562B of one T-shaped body 56B are engaged with the opposite recessed grooves 57B of the adjacent battery cells 10B in a back-forth movable manner in the stacking direction (X-direction), it is possible to suppress more compactly the battery cells 10B from separating upward from the cooling part 54. Consequently, the battery module 10P can be provided capable of compactly suppressing the battery cells 10B from upward displacement and thus improving the cooling performance of the battery cells 10B.

Each of the battery cells 10B of the battery module 10P in the first modified example is also configured such that the joining portion 113B between the long side wall portion 111 formed with the recessed groove 57B (the engagement part 57) and the lower short side wall portion 112b includes a corner portion 113BK formed at a right angle, as shown in FIG. 4, throughout in the axial direction (Z-direction), and further has a thick wall thickness inside of the battery can 1B to the extent that does not contact the electrode body 2. Therefore, the recessed groove 57B (the engagement part 57) can be designed with a more deeply recessed shape in the width direction (X-direction) of the lower short side wall portion 112b, compared to a configuration that the recessed groove 57B (the engagement part) is provided in the joining portion 113 between the long side wall portion 111 and the upper short side wall portion 112a. This can provide a wider engagement area between the protruding end portion 562B of the T-shaped body 56B and the recessed groove 57B. It is therefore possible to reliably suppress upward displacement of the battery cells 10B.

### Second Modified Example

A battery module 10P in a second modified example differs from the battery modules 10P in the embodiment and the first modified example described above in that each of the positionally-fixing parts 56 of the restraint mechanism 5 is an umbrella-shaped protrusion member 56C including a base portion 561C fixed on the upper surface 54U of the cooling part 54, between adjacent battery cells 10C, and extending in the extrusion direction (Z-direction) and that the engagement part 57 of each battery cell 10C is a recessed groove 57C in which a locking claw 562K of one of outer edge portions 562C, protruding from the base portion 561C of the umbrella-shaped protrusion member 56C on both sides in the stacking direction (X-direction), is engaged so as to be movable back and forth in the stacking direction (X-direction) within the groove.

Specifically, as shown in FIG. 5, a battery can 1C of each battery cell 10C includes a recessed groove 57C located in a joining portion 113C between the long side wall portion 111 and the lower short side wall portion 112b and extending in the axial direction (Z-direction) with an approximately trapezoidal cross-section, which is recessed in the width direction (X-direction) of the lower short side wall portion 112b. The recessed grooves 57C are formed on both ends of each battery cell 10C in the stacking direction (X-direction). Each recessed groove 57C is formed, on its lower end, with a locking claw 57CJ protruding upward in the vertical direction (Y-direction). In the battery module 10P in the second modified example, for example, when the case body 11C has a rectangular tubular shaped formed by extrusion molding in the axial direction (Z-direction) of the case body 11C and the recessed grooves 57C of the case body 11C are formed simultaneously during extrusion molding of the case body 11C in the axial direction (Z-direction), the battery cell 10C can be achieved including the case body 11B efficiently provided with the high-precision recessed grooves 57C in the axial direction (Z-direction). However, the method for forming the recessed grooves 57C is not limited to the above; for example, the recessed grooves 57C may be provided after forming or even before forming the rectangular tubular case body 11C.

The restraint mechanism 5 is further formed, on the upper surface 54U of the cooling part 54, with the umbrella-shaped protrusion members 56C each having an umbrella-shaped cross-section and extending in the axial direction (Z-direction) under the intervening member 51 interposed between adjacent battery cells 10C. Each umbrella-shaped protrusion member 56C includes the base portion 561C and the outer edge portions 562C protruding outward from both sides of the base portion 561C in the stacking direction (X-direction). The outer edge portion 562C of the umbrella-shaped protrusion member 56C enters in the recessed groove 57C, and the locking claw 562K extending downward from the outer edge portion 562C in the vertical direction (Y-direction) is engaged with the recessed groove 57C, so that the locking claw 562K of the outer edge portion 562C of the umbrella-shaped protrusion member 56C is allowed to contact with or separate from the locking claw 57CJ of the recessed groove 57C.

In the battery module 10P in the second modified example described above, since the locking claw 562K of the outer edge portion 562C of the umbrella-shaped protrusion member 56C is engaged the recessed groove 57C, it is possible to more reliably suppress the battery cells 10C from upward separating from the cooling part 54 on which the umbrella-shaped protrusion members 56C are fixed. Consequently, the battery module 10P can be provided capable of reliably suppressing the battery cells 10C from upward displacement and thus improving the cooling performance of the battery cells 10C.

Each of the battery cells 10C of the battery module 10P in the second modified example is also configured such that the joining portion 113C between the long side wall portion 111 formed with the recessed groove 57C (the engagement part 57) and the lower short side wall portion 112b includes a corner portion 113CK formed at a right angle, as shown in FIG. 5, throughout the axial direction (Z-direction), and further has a thick wall thickness inside of the battery can 1C to the extent that does not contact the electrode body 2. Therefore, the recessed groove 57C (the engagement part 57) can be designed with a more deeply recessed shape in the width direction (X-direction) of the lower short side wall portion 112b, compared to a configuration that the recessed groove 57C (the engagement part) is provided in the joining portion 113 between the long side wall portion 111 and the upper short side wall portion 112a. This can provide a wider engagement area between the locking claw 562K of the outer edge portion 562C of the umbrella-shaped protrusion member 56C and the recessed groove 57C. It is therefore possible to reliably suppress upward displacement of the battery cells 10C.

Moreover, the engagement parts 57 (57A, 57B, 57C) of the battery module 10P in the above-described embodiment and others are each provided extending in the axial direction (Z-direction) in the joining portions 113 between each long side wall portion 111 and the lower short side wall portion 112b. However, the configuration is not necessarily limited thereto. For example, engagement parts may be provided in any portions (the long side wall portions, lower short side wall portions, and upper short side wall portions) other than the joining portions 113 of the battery cans 1, 1B, and 1C.

### REFERENCE SIGNS LIST

1, 1B, 1C Battery can
2 Electrode body
5 Restraint mechanism
10, 10B, 10C Battery cell
10P Battery module
11, 11B, 11C Case body
11T End portion
12 Lid body
51 Intervening member
54 Cooling part
54U Upper surface
55 Connecting plate
56 Positionally-fixing part
56A Rod-shaped body
56B T-shaped body
56C Umbrella-shaped protrusion member
57 Engagement part
57A Insertion hole
57B, 57C Recessed groove
111 Long side wall portion
112a Upper short side wall portion
112b Lower short side wall portion
113, 113B, 113C Joining portion
561B, 561C Base portion
562B Protruding end portion
562C Outer edge portion
562K Locking claw
ND Secondary battery

What is claimed is:

1. A battery module comprising:
a plurality of battery cells, each constituting a secondary battery and including:
an electrode body; and
a battery can made of metal, including:
a case body in which the electrode body is housed, the case body having a rectangular tubular shape with end portions that open at both ends in an axial direction and including a pair of long side wall portions, and an upper short side wall portion and a lower short side wall portion perpendicular to the long side wall portions; and
a pair of lid bodies closing the end portions of the case body; and
a restraint mechanism restraining the plurality of battery cells, stacked with the long side wall portions of the battery cells adjacently arranged facing each other, from both ends in a stacking direction, the restraint mechanism including a cooling part for cooling the battery cells by contact with the lower short side wall portions, wherein
the restraint mechanism includes at least one positionally-fixing part for fixing the battery cells in place in a vertical direction,
the at least one positionally-fixing part is engaged with an engagement part provided in the case body, and
the at least one positionally-fixing part and the engagement part are engaged with each other with a space therebetween in the stacking direction.

2. The battery module according to claim 1, wherein the engagement part is provided in a joining portion between each of the long side wall portions and the lower short side wall portion and extends in the axial direction of the case body.

3. The battery module according to claim 1, wherein
the restraint mechanism includes:
pressure plates applying pressure onto outermost ones of the battery cells staked in the restraint mechanism; and
connecting plates connecting the pressure plates,
the at least one positionally-fixing part is a rod-shaped body supported to be movable in the stacking direction by the connecting plates, and extends in the axial direction of the case body, and
the engagement part is an insertion hole through which the rod-shaped body is inserted to pass through the lid bodies contacting the connecting plates.

4. The battery module according to claim 2, wherein
the restraint mechanism includes:
pressure plates applying pressure onto outermost ones of the battery cells staked in the restraint mechanism; and
connecting plates connecting the pressure plates,
the at least one positionally-fixing part is a rod-shaped body supported to be movable in the stacking direction by the connecting plates, and extends in the axial direction of the case body, and
the engagement part is an insertion hole through which the rod-shaped body is inserted to pass through the lid bodies contacting the connecting plates.

5. The battery module according to claim 1, wherein
the at least one positionally-fixing part is a T-shaped body placed between the battery cells adjacently arranged in the stacking direction, the T-shaped body including a base portion fixed on an upper surface of the cooling part and extending in the axial direction of the case body, and
the engagement part is a recessed groove in which each of protruding end portions of the T-shaped body, protruding from the base portion on both sides in the stacking direction, is engaged to be movable back and forth in the stacking direction within the recessed groove.

6. The battery module according to claim 2, wherein
the at least one positionally-fixing part is a T-shaped body placed between the battery cells adjacently arranged in the stacking direction, the T-shaped body including a base portion fixed on an upper surface of the cooling part and extending in the axial direction of the case body, and
the engagement part is a recessed groove in which each of protruding end portions of the T-shaped body, protruding from the base portion on both sides in the stacking direction, is engaged to be movable back and forth in the stacking direction within the recessed groove.

7. The battery module according to claim 1, wherein
the at least one positionally-fixing part is an umbrella-shaped protrusion member placed between the battery cells adjacently arranged in the stacking direction, the umbrella-shaped protrusion member including a base portion fixed on an upper surface of the cooling part and extending in the axial direction of the case body, and
the engagement part is a recessed groove in which a locking claw of each of outer edge portions of the umbrella-shaped protrusion member, protruding from the base portion on both sides in the stacking direction, is engaged to be movable back and forth in the stacking direction within the recessed groove.

8. The battery module according to claim 2, wherein
the at least one positionally-fixing part is an umbrella-shaped protrusion member placed between the battery cells adjacently arranged in the stacking direction, the umbrella-shaped protrusion member including a base portion fixed on an upper surface of the cooling part and extending in the axial direction of the case body, and
the engagement part is a recessed groove in which a locking claw of each of outer edge portions of the umbrella-shaped protrusion member, protruding from the base portion on both sides in the stacking direction, is engaged to be movable back and forth in the stacking direction within the recessed groove.
